(19) United States
(12) Patent Application Publication
(10) Pub. No.: US 2008/0097783 A1
(43) Pub. Date: Apr. 24, 2008

(54) System and method for preference-based account enrollment

(76) Inventor: Gregory Fx Iannacci, Stoneham, MA (US)

Correspondence Address: GREGORY FX IANNACCI, 30 KEENE STREET, STONEHAM, MA, 02180, US

(21) Appl. No.: 11/981,354

(22) Filed: Oct. 31, 2007

Related U.S. Application Data
(63) Continuation-in-part of application No. 09/932,808, filed on Aug. 17, 2001, now Pat. No. 7,318,049.
(60) Provisional application No. 60/249,746, filed on Nov. 17, 2000.
(60) Provisional application No. 60/263,251, filed on Jan. 22, 2001.

(51) Int. Cl. G06Q 99/00

(52) U.S. Cl. 705/1

(57) ABSTRACT

The present invention relates to an on-line, interactive, and fully integrated feature-based account enrollment management program that monitors, evaluates, acquires, activates, and manages accounts and executes functions to acquire, activate, and make available account structures for users by discovering, applying, managing, and automating appropriate acquisition and administration actions.

Continuation-in-part patent application of U.S. patent application Ser. No. 09/932,808.

### CROSS-REFERENCE TO RELATED APPLICATIONS

This application is a continuation-in-part of U.S. patent application Ser. No. 09/932,808 WHICH IS HEREBY INCORPORATED IN THIS APPLICATION, entitled System and Method for an Automated Benefit Recognition, Acquisition, Value Exchange, and Transaction Settlement System Using Multivariable Linear and Nonlinear Modeling, filed Aug. 17, 2001, naming Gregory Fx Iannacci as inventor, which is based on U.S. Provisional Patent Application No. 60/249,746, entitled System and Method for Establishing and Executing a Payment, Discount, and Incentive Transaction System, filed 17 Nov. 2000, naming Gregory Fx Iannacci as inventor, and U.S. Provisional Patent Application No. 60/263,251, entitled System and Method for a Universal Incentive and Award Acquisition, Value Exchange, and Payment System, filed 22 Jan. 2001, naming Gregory Fx Iannacci as inventor, and further related to U.S. patent application Ser. No. 11/474,832, entitled Interoperable Account Junctions and Omnicompetent Value Trusts, filed 26 Jun. 2006, naming Gregory Fx Iannacci as inventor. The entirety of all such patent applications is incorporated herein.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to an on-line, interactive, and fully integrated feature-based account enrollment management program that monitors, evaluates, acquires, activates, and manages accounts and executes functions to acquire, activate, and make available account structures for users by discovering, applying, managing, and automating appropriate acquisition and administration actions.

More particularly, the present invention relates to the field of account enrollment administration processing systems and, more exactly, to account application functions that may be established and executed to monitor, identify, compare, determine, select, acquire, activate, and utilize available and preferred accounts and, consequently, accept and disclose related acquisition and subscription information and instructions, and such other relevant account operations, for the acceptance and disclosure of user information to related parties to affect actions, applications, accounts, and related data operations.

2. Description of the Prior Art

Applying for an account, such as a credit card or merchant loyalty account, is a well known process. Generally, a user expends personal time and resources to discover an account they desire to acquire, e.g., a credit card, perhaps by reviewing an advertisement proffering certain convenience or benefit features. The user will then be required to journey to and access an appropriate facility, e.g., a bank office or an Internet website, in order to submit an enrollment application to acquire the credit card. The user will submit personal information in order to meet the criteria for enrollment. Upon providing sufficient information to the issuing authority, and possibly being subjected to a review process, the applicant will secure an account.

This current process is burdensome for an individual. The considerable time and effort involved with discovering suitable accounts of interest and then accessing an application site may cause the potential applicant to avoid the application process since many people want to save time and would rather be presented with convenient account enrollment application methods. During the application process, the demand by an account issuer for personal information and, again, the time and effort required to read, determine, and present necessary user details is an impediment to complete an enrollment application for many people.

Further more, account issuers generally do not provide an incentive for the applicant to provide information beyond the generic account features which may be associated with the selected account program.

Over all, the effort involved in the discovery of accounts of interest to a person and the methods of securing an account are obstacles in the efficient operation of business.

The aforementioned account discovery and enrollment application processing system approach is functionally limited in that: (a) a person must manually discover those accounts which provide features offered by the account which are desirable; (b) a person must journey to an application site to make an application for an account; and, (c) a person must provide information according to the account issuer's requirements for issuance of an account and list their personal information without any escalating incentives to provide sensitive personal data.

Accordingly, due to the burdensome time and effort involved in the current application process, many people may be deterred from completing an enrollment application and thus not be availed of benefits which would likely improve their lifestyle. As such, the prior art has the disadvantage that the application and use of accounts is limited by the amount of time and effort a person wants to invest in managing the discovery and enrollment application processes.

People confront a growing assortment of accounts providing features such as settlements, incentives, rewards, coupons, and marketing promotions. In general, consumers are unable or unwilling to review the range of accounts, identify which ones apply to them, and then make and complete an enrollment application for a selected account.

Another disadvantage is that securing an account which provides useful features is dependent on a person discovering applicable account opportunities and then remembering to apply for the appropriate account.

Previously proposed enhancements have not allowed people to state their preferred account features which they desire to obtain and make use of, discover accounts providing such preferred features, and then automatically securing such accounts for a user's benefit. More particularly, previously proposed enhancements to enrollment application systems have not allowed people or organizations to directly adjust personal information elements that would be immediately delivered during the application process and those personal information elements that would not be delivered. Further more, the delivery of data elements has not been afforded advantageous intervention or incentive provisions and adjustments between the parties during an account application.

Each of the aforementioned prior art systems and processes require considerable time and effort on the part of a person if they seek to obtain benefits related to an account. As such, the need for a person to search for accounts either manually or using additional systems and processes can be costly, can diminish the intended value of the accounts requiring such additional time, effort, and processes, and can limit the probability of securing an account.

It is the goal of the present invention to make account discovery and the manner of securing an account a simplified undertaking for people.

Accordingly, the shortcomings associated with the prior art have heretofore not been adequately addressed. The present invention addresses such limitations by providing a system and processing approach that have not previously been proposed.

### PRIOR ART EXAMPLES AND ASSOCIATED LIMITATIONS

If a consumer wanted to subscribe to a merchant loyalty program (e.g., CVS Corporation's ExtraCare, Southwest Airlines' Rapid Rewards, Morgan Stanley Company's Discover Cashback Bonus/all trademarks and company names are used for referential purposes and are the property of their respective owners), they would need to: discover the account which provides user-preferred features; access an enrollment application location; complete an enrollment application; and, secure an account. The effort to discover and determine preferred accounts, conform to diverse enrollment application standards, and complete irregular information formats presents not only many inefficient methods but also an incompetent processing structure.

Account enrollments are generally offered using manual and automated means, with automated event processes possibly involving digitized personal profiles, machine-readable privacy policies, and automated data exchanges. While some enrollment application methods exist that assist with pre-populating electronic forms with personal information, such applications are constrained, for example, in their ability to accommodate feature preferences, assimilate non-standard data tags, and dynamically integrate new enrollment data compliance options. Although these account-opening applications have long existed, the present invention exceeds such capabilities by incorporating unique and novel preference-based account enrollment options.

Marketplace participants (e.g., consumers, merchants) are presently limited in their means to conveniently and automatically initiate, coordinate, and secure accounts, for example, shopper loyalty program accounts. This is due in part to a difficult discovery and subscription process. At the present time, there are five general stages involved with issuer accounts: 1) issuer definition of program requirements and features; 2) publication of the program by the issuer and discovery by an interested party; 3) the provision of information by an applicant sufficient to satisfy a request for information by the issuer; 4) the evaluation of an applicant's information with reference to the issuer's compliance requirements to produce a decision; and, 5) the announcement of a disposition to the concerned parties.

The prior art is deficient in that it is based on each account issuer setting its account features and creating application information requirements instead of configuring its enrollment process to accommodate an applicant's data precondition priorities. To improve the prior art, the present invention builds a system that changes static account features configured by the issuer into dynamic account features selected and/or negotiated by the applicant.

As account enrollment activities involving the request and provision of personal and demographic information expand, the prior art is not aligned with providing effective solutions to assess and integrate an issuer's information compliance requirements and the applicant's data disclosure compliance priorities. Eliminating data element conflicts, executing negotiated data exchanges, dynamically configuring feature sets, and implementing real-time data updates in enrollment ratification and management processes will provide benefits to users and society.

### REFERENCE PUBLICATIONS

Current descriptions of these long standing methods include examples such as the following references.
Using the Profile Assistant, Microsoft Corporation, Referenced 21 Jun. 2006 from http://msdn.microsoft.com/library/default.asp?url=/workshop/management/profile/profile_assistant.asp
Platform for Privacy Preferences (P3P) Project, World Wide Web Consortium (W3C), Referenced 21 Jun. 2006 from http://www.w3.org/P3P/
Creating a CVS ExtraCare Account, CVS Corporation, Referenced 22 Jun. 2006 from https://www.cvs.com/CVSApp/cvs/gateway/registerextracare?LOGINMSG=XTRACAREMSG
Get One from American Express, American Express Company, Referenced 22 Jun. 2006 from https://www201.americanexpress.com/cards/Applyfservlet?csi=51/23000/b/10/1736832841/173165431719/0/n
Account Aggregation and Integration, Yodlee, Inc., Referenced 22 Jun. 2006 from http://corporate.yodlee.com/technology/platform_overview.html

### SUMMARY OF THE INVENTION

This continuation-in-part patent application relies upon the specification disclosures contained within U.S. patent application Ser. No. 09/932,808 to provide the understanding of the present invention. In addition, concepts as further revealed in the present invention are considered to be based on practical, logical, and reasonable extensions and implications of the means as disclosed in U.S. patent application Ser. No. 09/932,808 for the proper working operation of such described means.

As disclosed in U.S. patent application Ser. No. 09/932,808:
AUTOMATIC ACCOUNT CREATION WHEN REQUIRED TO OBTAIN BENEFITS (reference page 43, lines 10-19)
   In addition, the ability for the present invention to provide various transaction and consumer information to a benefit option supplier or payment/award issuer, as authorised by related parties, at the time of an action or transaction in order to obtain a benefit item is also contemplated. For example, an “Instant-In” account enrollment system and process would automatically and immediately enroll a universal account owner in a membership program by supplying approved owner information to the option supplier or payment/award issuer if such action was required to obtain beneficial option offers and if the owner permitted such Instant-In functions. It should be noted that the “Instant-in” feature also is available for merchants to use in order to open new payment processing or incentive award accounts.
PROVISIONAL USE ACCOUNTS (reference page 59, lines 7-21)
   It is also contemplated that in addition to having preestablished payment or redemption accounts, a universal account also may have provisional payment or redemption shell accounts available for immediate activation. A provisional shell account would consist of information such as a payment or award issuer and a status code or identifier code pre-qualifying the universal account owner to obtain a payment or award account, such as a Fleet Visa credit card account. No actual credit card account would exist until such time as an advantageous option offer required the use of such a payment or award account. At such an advantageous time when the Fleet Visa account may be used to acquire the best option items, the pre-qualification information would be transmitted to Fleet in order to immediately create and activate a Visa credit card account for the universal account owner. Upon activation, Fleet would transmit a payment account identifier, and such other relevant account items, for use by the universal account owner and, consequently, by the universal server processing system and the related transaction in order to acquire the best option offers. Such an arrangement would be similar for merchant processing provisional shell accounts.

In view of the deficiencies of the prior art discussed before, and based on the previous patent application specification, the present invention is advantageous in that it provides an on-line, interactive, and fully integrated preference-driven account management system that monitors account offerings, evaluates account feature sets, exchanges data elements, and secures and activates accounts by guiding and automating appropriate discovery, enrollment, and account actions. It is a system and method for evaluating a catalog of accounts and associated feature sets; determining beneficial accounts according to a user's preferred feature set profile; and, producing the instructions, actions, and means of securing and activating selected accounts that provide beneficial and preferred value to the user. Such accounts may include, for example, accounts related to banking, investment, insurance, merchants, fraternal organizations, governmental agencies, and in general any account which requires a prospective member to supply information to an account issuer during an enrollment process.

The present invention allows a user to: declare preferred account features, e.g., incentives such as airline miles; set information provision conditions for use during account applications; secure accounts either proactively or at the time of a transaction whereby the automatic enrollment in an account will provide preferred features for the user; and, activate either a proactively established provisional account structure or a fully constituted account structure for employment by the user. The present invention can quickly master the intricacies of all issuers' feature sets and enrollment application requirements. All a user must know in order to optimize their account selection is how to use just one account management system.

The present invention's key advantage is that it offers personalized preference-driven account processes to users for producing account feature set determinations according to a user's configured preference profile. The present invention integrates with conventional payment, settlement, incentive, and enrollment systems.

In addition, the present invention functions with any account provisioning or application service processing system and extracts and exposes account structures that enable the present invention to evaluate and determine linkages from an extensive catalog of accounts and feature sets that will provide individualized value solutions.

Operational Overview

The present invention is commonly described in the related U.S. patent application Ser. No. 09/932,808, No. 60/249,746, and No. 60/263,251 which provide the basis for this continuation-in-part patent application, and further disclosed in the following subject matter.

The present invention allows a user to: establish or connect to a personal information data store; declare preference features to guide account selection processes; indicate whether automatic account enrollment functions will be permitted; establish conditions for providing profile information during an account enrollment process; scan all available accounts on either a continuous or a requested basis; compare the declared preference features to the account feature sets of the scanned accounts; evaluate the correspondence and value between the declared preference features and the account feature sets of the scanned accounts; determine which, if any, scanned accounts are sufficiently beneficial for the user to secure; depending if the status of the automatic enrollment option allows system-initiated enrollment, either proactively supplying designated user profile information during an enrollment process to secure a provisional account structure for future activation and use, or supplying permitted user profile information during an enrollment process to secure a fully constituted account structure for immediate activation and use; disclose user information according to data disclosure compliance standards; condition the disclosure of selected user profile information during an enrollment process with adjustments in account feature sets offered by the account issuer; record the activity and generated information of determined accounts, enrollment processes, data exchanges, account feature sets, application outcomes, and appropriate constituted account details; and, activate either provisional account structures or fully constituted account structures at appropriate times for application in user transactions.

Users create an account profile such as the one shown in FIG. 3. A user will declare preferred features in their profile for use in processing activities. Once the user creates a profile, the present invention will scan all available account resources for account feature sets that match the user-declared preferred features.

The particular user highlighted in FIG. 3 has declared a preference to use low interest rate financing offers (reference numeral 330). After conducting a scan of all available account resources, an account and feature set which the user does not presently possess may be determined as valuable for the user. If the user has selected to allow the system to conduct automatic enrollment functions, the system will contact the account issuer and begin the exchange of communications to ascertain the account enrollment requirements. User profile information will be disclosed to the account issuer during the enrollment process as guided by the data compliance directives set forth in the user profile concerning which data may be provided, which data is to be withheld, and which data may be disclosed upon adjusted issuer feature sets or incentives.

The present invention may negotiate with an account issuer for adjusted benefits in order to induce the release of conditional user information during an enrollment process. The present invention, in one embodiment, then will automatically select the user profile information to supply during an enrollment process according to user directives and incentives in order to secure either a provisional account structure or a fully constituted account structure. The details of all such account management and processing activity will be stored in the system and made available to appropriate parties at appropriate times.

The present invention eliminates the burden of a user needing to discover accounts which provide preferred feature sets and engaging in an enrollment process to provide personal information. This unique invention allows a consumer to be availed of the most advantageous account opportunities while avoiding the requirement to spend time on manual operations to achieve those opportunities.

Enrollment Overview

The present invention creates a user and account issuer network that matches user feature preferences with issuer delivered features and implements the means to automatically acquire those accounts that are deemed preferred for the user. Users complete a personal profile listing features preferred by them, e.g. airline miles, cash discounts, lowest fees, etc. A scan of account resources is conducted and all accounts and associated features not presently in the possession of the user are then matched against this preference profile to automatically select the opportune accounts for enrollment.

In point of fact, a user of the present invention could be a consumer declaring preferred features, such as airline miles, or a merchant declaring preferred features, such as lowest payment processing costs, in order to determine an account which would be suitable for an automatic enrollment. Such scope of users and declarations is contained in the related U.S. patent application Ser. No. 09/932,808.

As one example after completing the declaration of a user's preferred features (e.g., lowest interest rate) and if the user permitted the system to engage in automatic enrollment operations, the present invention would conduct a scan of all available account resources. If it was determined that there is not an available account providing features more favourable than accounts already in the possession of the user, then no enrollment activity would be conducted. If, on the other hand, an account was discovered based on an interest rate evaluation which provides a feature set including at least the element of an interest rate which is superior to the interest rate of accounts already in the user's possession, then an automatic enrollment process would be initiated for the user.

The enrollment process would consist of a communication exchange between the user and the issuing authority to ascertain the user data elements to be provided for the enrollment application. The present invention would review the issuer's data requests (e.g., name, address, social security number) and compare the data requests to the user's data disclosure compliance standards. As displayed in FIG. 2, user profile RC3 allows auto-enrollment and has set the data disclosure status for Name, Address, Social Security Number, Date of Birth, and Gender. It should be understood that such presented data elements are merely for concise representation and example purposes only and do not indicate a limitation, either logical or physical, in the data elements which may be encompassed by the present invention. During the enrollment process, it will be discovered that the issuer requests the user's Name. Upon review of the data element disclosure conditions, the user's Name will be unconditionally provided during an enrollment application. The issuer further requests an Address to which the user has indicated such data element will be unconditionally provided. It is discovered that the issuer requests a Date of Birth to which the user has indicated such data element may be conditionally released. A conditional release may be based on the issuer's account feature set for enrollment and also on immediate adjustments to the feature set to inspire the release of conditional user information. The issuer also requests the user's Gender, to which the user has indicated that Gender is not to be disclosed.

Upon the completion of a user disclosing data elements as requested and/or inspired by the issuer, a determination will be made if the supplied data elements are sufficient to complete an enrollment application. If there are data elements listed as conditional by the user and required by the issuer, a recursive step of inspiration may ensue to generate a complete enrollment application. Should a deficit of data elements exist which the issuer is not willing to accept and the user is not willing to satisfy, then the enrollment application process will be terminated in a conventional manner. If, on the other hand, it is determined that sufficient data elements have been provided, then the enrollment application may be submitted to the issuer for a review process.

At some time during the enrollment process, it will be declared by the present invention whether the enrollment application is intended to establish a provisional account structure or a fully constituted account structure. A provisional account structure would essentially involve completing an enrollment application as previously described, but merely securing some form of a pre-approved token for the chosen account which could be returned to the issuer for use at some future time and that would enable a fully constituted account to be immediately established and activated without the burden of an enrollment application and review to be completed. The other option would be for the present invention to indicate that a fully constituted account structure was to be established and activated for immediate use.

After completing any issuer review process, the result of such review, along with all other enrollment activity generated by the present invention, would be recorded in the user's profile system.

In one embodiment, when making a payment, a user may employ the system as described in U.S. patent application Ser. No. 09/932,808 and require the use of an account and feature set which the user does not currently possess. The present invention could be commissioned to operate its auto-enrollment means to secure and activate a preferred account.

In another embodiment, as described in U.S. patent application Ser. No. 09/932,808, the present invention may operate in advance of being instantly commissioned by proactively scanning available account resources as changes are made to the resource pool and then determining appropriate accounts which may be beneficial for the user at some future time. This operation would likely generate provisional account structures for activation in future transactions.

Basic System Requirements for System Connections

The present invention requires appropriate physical, electronic, and telecommunication connections to conventional payment networks, financial institutions, merchants, account issuers, enrollment systems, and all other parties and systems involved in applicable account enrollment activation and processing operations.

Present Invention Highlights

It is an advantage of the present invention that a user is able to declare feature preferences in either a local and/or remotely connected storage system and have a system utilize such user information to perform automatic discovery operations for advantageous accounts offering such preferred features.

Another advantage of the present invention is that enrollment applications will be automatically completed without user intervention.

A further advantage of the present invention is that data elements may be established with certain disclosure compliance characteristics and have such characteristics honored at the time when completing an enrollment application.

Another advantage is that a user may establish data disclosure compliance standards to provide, withhold, or conditionally disclose certain user data elements and thus employ such disclosure compliance standards to effect adjustments in an issuer's proffered account feature set and also to guide the completion of enrollment applications.

The present invention is also advantageous in that all discovery and enrollment activity will be stored for user review.

It should be understood that a computer program may be compiled to address all the various actions of the above disclosed functions and operations and a data processing system may activate and execute said program. The operations, processing, and logic of said computer program will be readily apparent to those skilled in the art of computer programming and database management system programming.

### BRIEF DESCRIPTION OF THE DRAWINGS

The present invention is described in detail below with reference to the following drawing figures of which:

FIG. 1 is a block diagram of a system for establishing and executing automatic account enrollment and management functions within a transactional processing system;

FIG. 2 is a diagram depicting the user account database table;

FIG. 3 is an illustration of a universal account owner's database information as depicted in FIG. 2 and according to the present invention;

FIG. 4A is a flow chart illustrating a process carried out according to a preferred embodiment of the present invention;

FIG. 4B depicts further steps carried out by the process started in FIG. 4A; and,

FIG. 4C depicts further steps carried out by the process started in FIG. 4A.

### DETAILED DESCRIPTION OF THE PREFERRED EMBODIMENTS

The present invention is described in detail below with regard to the drawing figures briefly described above. Like parts are referred to by like reference numerals.

Various implementations of the present invention consist of: a method that automatically discovers accounts proffering feature sets; a method to discern the decision of a user to engage in automatic enrollment functions; a method that coordinates the exchange of enrollment application data elements; a method that secures an account based on evaluating at least one account feature set; and, a method that activates a secured account. All embodiments may utilise a means for a user to view and select such data elements and accounts, and to transmit appropriate actions and information to related parties to settle an account enrollment application. In addition, all embodiments may be performed automatically without user intervention to conduct, select, and transmit appropriate actions and information to related parties to settle an account enrollment application.

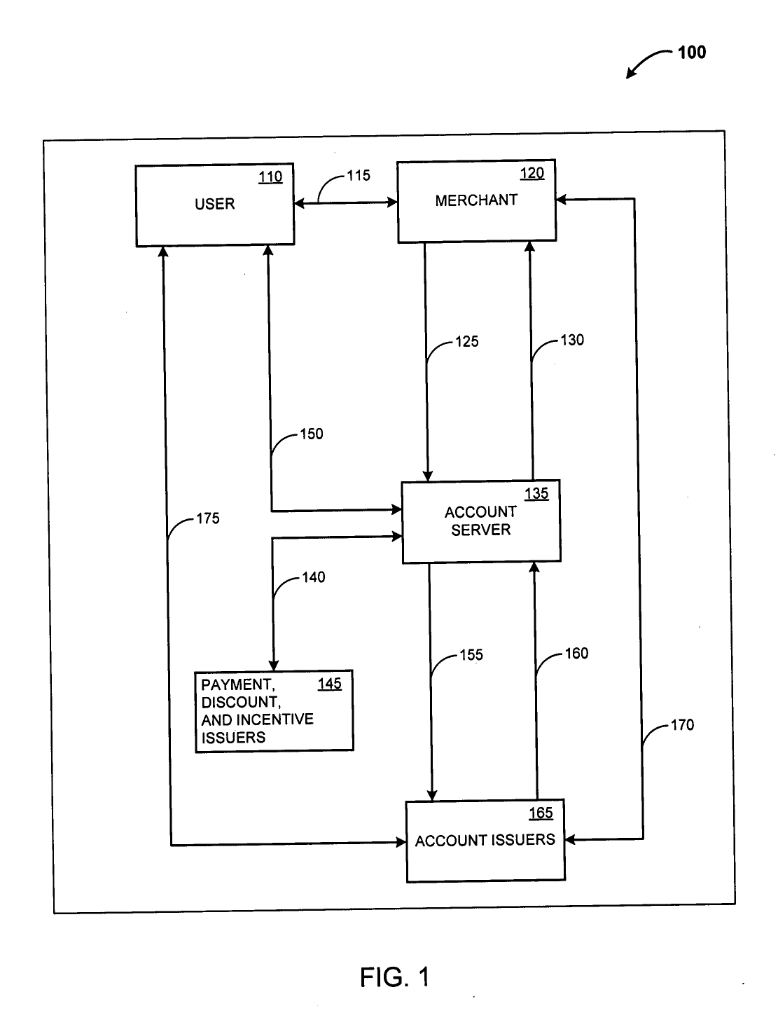

Referring now to FIG. 1, therein depicted is a block diagram of a system for establishing and executing account enrollment functions within an account processing system, such as, for example, within a credit card application system and an account server processing system, that includes such elements as accounts, feature sets, and data elements. System 100 is configured to allow users, merchants, and any party to use and take advantage of account discovery and enrollment functions, and appropriate system functions during, for example, an application to secure a credit card.

Regardless of the delivery devices and mediums that are chosen for implementation, system 100 and the present invention certainly contemplate the use of any connections and communications device and medium that will allow a user to communicate their profile information to an account issuer and other parties for appropriate execution to permit an automatic enrollment application process to be conducted for the user.

It should also be understood that account server information and accounts may be affected at times other than during point-of-sale transactions with activities involving such matters as, for example, system maintenance, account owner updates, environmental opportunities, proactive monitoring to prepare for future events and transaction conditions, e.g., time-sensitive terms, etc.

System 100 allows the use of discovery and enrollment functions that permit users to not only identify preferred account feature sets, but also enjoy the automatic enrollment functionality to remove the burden of completing enrollment applications.

From a high level, system 100 operates to allow a user 110 to interact with, for example, a merchant 120; an account server 135; payment, discount, and incentive issuers 145; and, account issuers 165 in ways not heretofore provided. User 110 and merchant 120 exchange information via link 115. Merchant 120 and account server 135 exchange information with each other via links 125 and 130, respectively.

Link 115 allows user 110 to exchange transaction related information, such as an account identifier delivered as a number, with merchant 120. Once received in the course of a transaction (e.g., a point-of-sale transaction), merchant 120 can then re-transmit (possibly via a credit card processor) such card number and other transaction information, such as a request to process a payment or refund, product identification codes, and amounts to account server 135 for appropriate processing and investigation for securing a merchant loyalty account. After account server 135 receives such information, account server can process the account request provided by merchant 120 by communicating with payment, discount, and incentive issuers 145 to determine and select appropriate account feature sets. Account server 135 continues to process the account request in accordance with functions corresponding to the declared preferences of the user 110, the merchant identifier originally provided by merchant 120, and the corresponding options made available by payment, discount, and incentive issuers 145 as well as account issuers 165.

Links 115, 125, 130, 155, 160, and 170 are intended to comprise and utilise conventional payment and settlement processing systems and account enrollment processing systems data links, such as those used in credit card application systems, as well as any state-of-the-art systems. For example, link 115 may involve a point-of-sale workstation and network, while links 125, 130, 155, 160, and 170 may involve a telecommunications or other network allowing for transaction data communications including the communication of account structure related information. Of course, any information transmission vehicles could be utilised to allow the functionality of system 100. In addition, of course, system 100 contemplates the use of the Internet and wireless mechanisms as communications mediums that could certainly be deployed for communication of such transaction and account related information. The Internet certainly would be preferred in electronic commerce settings in which the present invention is deployed. Wireless communication mediums (e.g., Bluetooth devices, Internet or data-enabled cellular telephones, RIM Blackberry device short messaging and paging services) would also be preferred in electronic commerce settings that feature mobility and personal connectivity capabilities in which the present invention is deployed. Personal, ultra mobile, and wireless connected computing devices are certainly envisioned for the deployment of the present invention. The use of such alternative communication and computing vehicles will be readily appreciated by those skilled in the art.

Links 140, 150, and 175 are intended to comprise and utilise conventional data communication processing system links, such as those used in the Internet or wireless communications (e.g., system-to-system computer networks, personal computer dial-up network connections, wireless digital appliances, paging systems and pager devices, data-enabled cellular telephones), as well as any state-of-the-art system links.

Regardless of the communications mediums and topologies that are chosen for implementation, system 100 and the present invention certainly contemplate the use of any communications medium that will allow a user, merchant, feature set suppliers, or account issuers to communicate account related information and feature sets to an account server processing system for appropriate process execution in order to effect related accounts. In addition, the use of encrypted communications and such related cryptographic methods is envisioned by the present invention to ensure the privacy and security of information and transactions. The use of such cryptographic methods will be readily appreciated by those skilled in the art.

The processing that occurs to allow the application of multiple functions, such as attempts to acquire conditional data elements, involves iterative and interactive type processing and will be readily appreciated by those skilled in the art of computer programming.

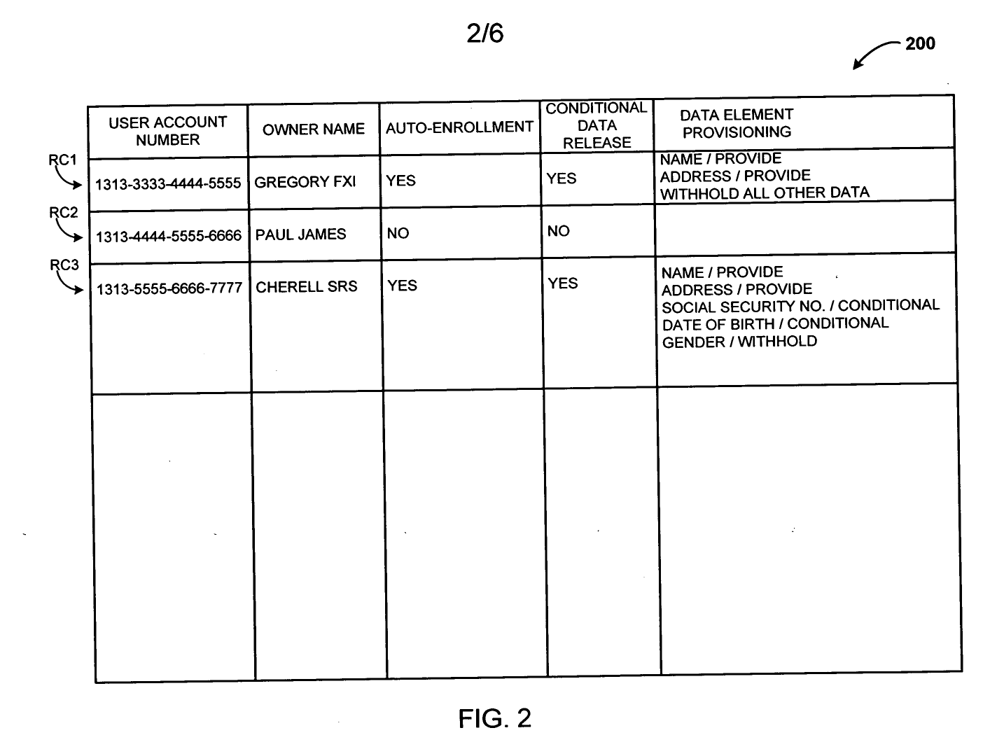

Referring now to FIG. 2, therein depicted is a diagram of a user database table 200 which is either maintained at an account server as shown in FIG. 1 or at some other location with the present invention having the right to access such user data at such remote location. In particular, account database 200 (hereinafter referred to as “table 200”) comprises a database management system table that is preferably used in a relational arrangement whereby table 200 is related to other tables in the particular database management system by way of common connections, columns, or table fields. Table 200 has a field structure including fields (from table left to right) USER ACCOUNT NUMBER, OWNER NAME, AUTO-ENROLLMENT, CONDITIONAL DATA RELEASE, and DATA ELEMENT PROVISIONING. Of course, table 200's field or column structure is simplified here for purposes of brevity; in actual implementation, many more fields may be used to record other account owner and related information and to record system parameters related to particular records in the database table. The fields form the columns of table 200 and the data records form the rows of table 200. The layout of table 200, including its appearance in FIG. 2, will be readily appreciated by those skilled in the art of database management system design and implementation. It should be noted that the columns and their apparent arrangement in table 200 are merely exemplary to enable one skilled in the art to make and use the present invention; no inferences should be drawn that the table structure (logically or physically) as shown is intended to limit the structure that is ultimately implemented.

The column identified with the label USER ACCOUNT NUMBER stores data representing the account identification code assigned to the respective account owner. The OWNER NAME column stores data representing the name of the universal account owner. The AUTO-ENROLLMENT column stores data representing whether the account owner will permit enrollment applications to be automatically initiated to secure an account. The CONDITIONAL DATA RELEASE column stores data representing whether the account owner will consider the release of data elements that are indicated to be conditional release fields. The DATA ELEMENT PROVISIONING column stores data representing the data elements that are available for disclosure during an enrollment application and the disclosure setting (e.g., Provide, Conditional, Withhold) for each data element. A disclosure setting of Provide would disclose the data element (e.g., user's name) during an enrollment application process, while a setting of Withhold would prevent the data element from being disclosed, while a setting of Conditional would possibly request adjusted feature set options before releasing the data elements requested during an enrollment application. User feature set preferences would be contained within the user profile record as stored in table 200 or accessible to account server 135.

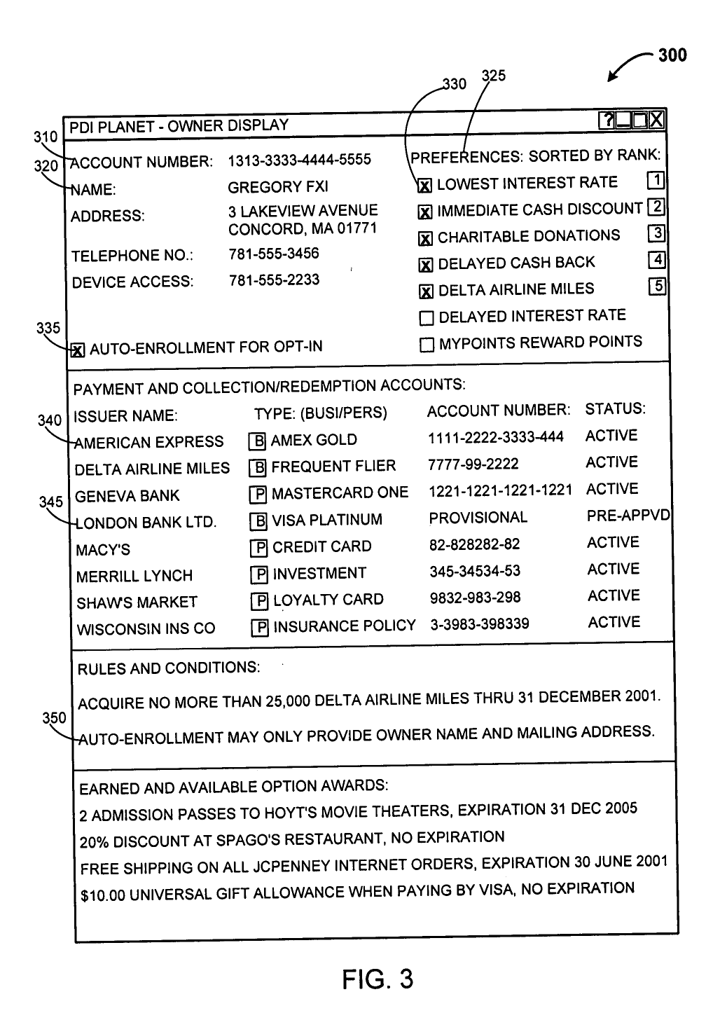

Referring now to FIG. 3, therein depicted is a user's database information illustrated as a computer system screen display according to the present invention. In particular, screen 300 resembles a typical computer system screen display as a representation of table 200 (FIG. 2) and record RC1 (FIG. 2) preferences and priority rankings, rules, and conditions in the form of system information and corresponding notices printed on screen 300 to indicate the guidelines of operation to be carried out or executed by account server 135 in accordance with such system information. The implementation details necessary to transport or otherwise deliver a screen display like screen 300 to a user conveniently using electronic communication devices producing sight, sound, or touch formats will be readily apparent to those skilled in the art.

A preference section 325 includes information about user 320's preferences, such as option 330 having a selection mechanism (e.g., a checkbox to select or deselect an option), a descriptive name of LOWEST INTEREST RATE, and a priority rank of 1 (e.g., first preferred option to be acquired if possible). Preference section 325 is reviewed when seeking to discover accounts in which user 320 may employ the automatic enrollment function 335 to secure accounts and feature sets not already in the possession of the user such as account 340. The automatic enrollment method may also function to proactively secure provisional account structures for future activation such as account 345. The disclosure of data elements during the enrollment application process will be guided by established guidelines as indicated by 350 and table 200.

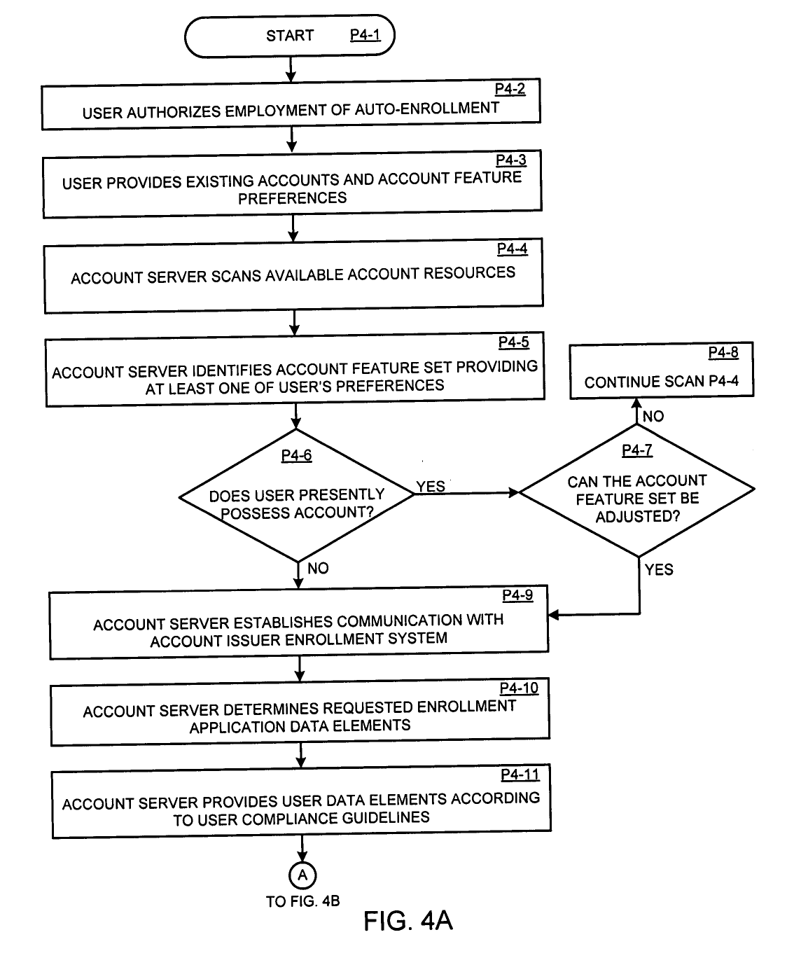

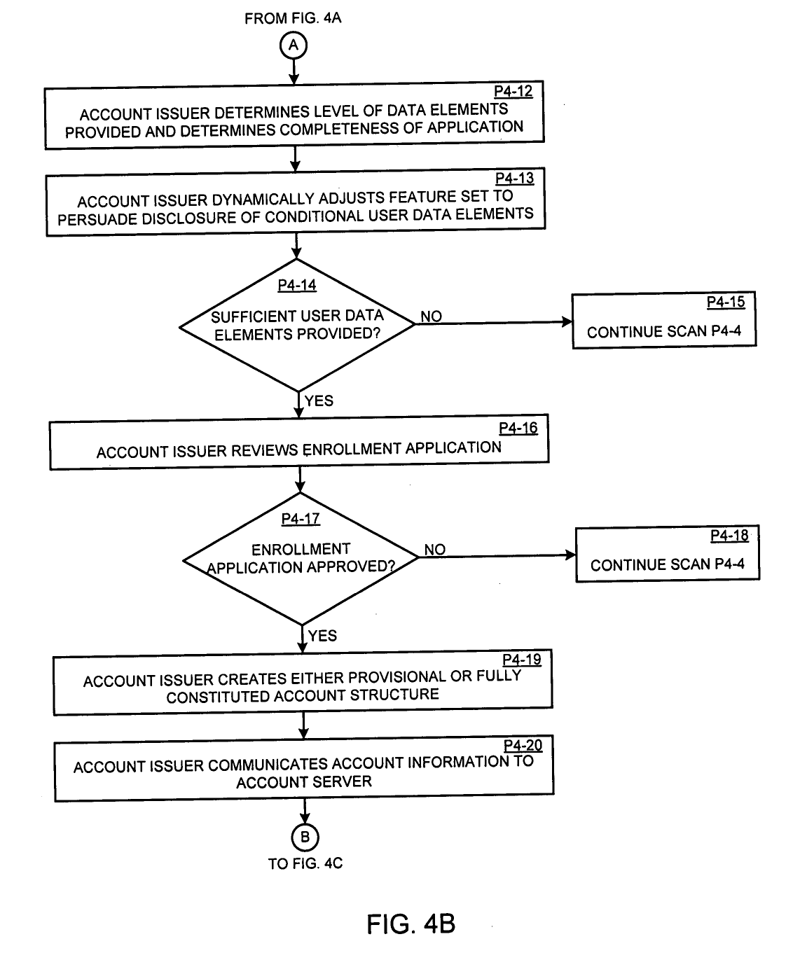

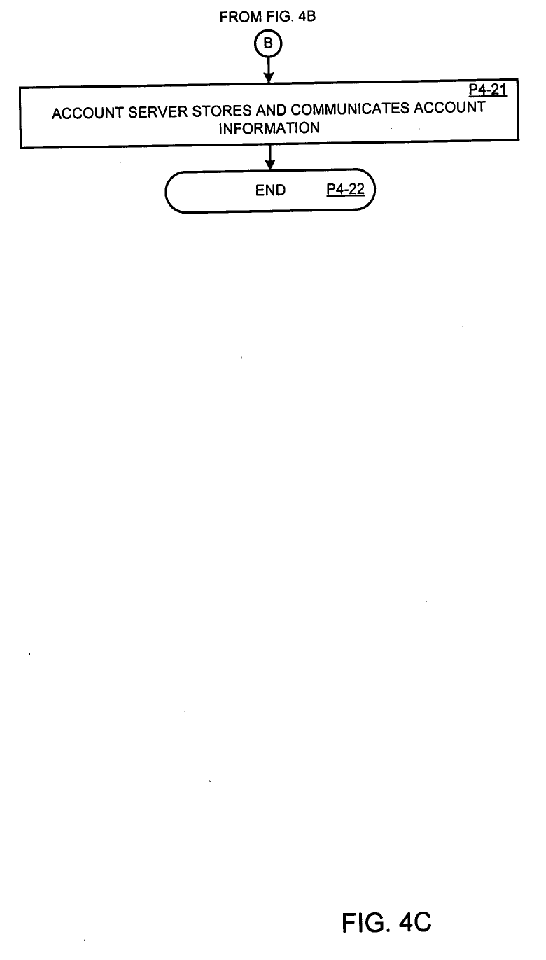

Referring now to FIGS. 4A-4C, therein depicted are flow charts illustrating a preferred embodiment of a structure for processing or otherwise executing automatic account enrollment functions along with discovering, evaluating, applying, and recording results within an account server processing system utilising data entry systems, or other data entry mechanisms, such as system 100 depicted in FIG. 1. The process depicted in FIGS. 4A, 4B, and 4C is, in part, intended to be carried out by the data processing system illustrated as system 100 in FIG. 1 and described above and also is, in part, intended to be carried out by account issuers (FIG. 1, reference numeral 165) and possibly payment/award issuers (FIG. 1, reference numeral 145) as connected to data processing system 100 illustrated in FIG. 1. The process depicted in FIGS. 4A-4C also is intended to illustrate the steps carried out by a user, an account server, and account issuers during a transaction. Moreover, the process depicted in FIGS. 4A-4C contemplates the use and operation of functions based on preference identifiers, feature set structures, account identifiers, user information, and account information that are retrieved or presented and processed during a transaction.

More particularly, the process depicted in FIGS. 4A-4C is intended to enable a system and process to automatically obtain accounts by establishing and executing discovery, evaluation, and enrollment application functions that ultimately identify preferred accounts and then determine appropriate enrollment methods for use to secure and activate said accounts and then produce relevant information of said accounts for use, either immediately or delayed, to related parties.

Processing starts at Step P4-1 and immediately proceeds to Step P4-2 where a user authorizes the use of automatic enrollment functions to secure and activate accounts. It should be noted that a user may provide such authorization directly to the account server (FIG. 1, reference numeral 135) or the account server may become aware of the user's authorization through communication with other systems employed by the user.

Thereafter, processing then proceeds to Step P4-3 where the user declares their existing accounts and account feature preferences (FIG. 3, reference numerals 330 and 340). It should be noted that a user may provide such information directly to the account server or the account server may become aware of the user's information through communication with other systems employed by the user. It should be noted that Steps P4-2 and P4-3 may operate interchangeably whereby a user first engages the use of the automatic enrollment system and then discloses their existing accounts and feature preferences by entry into the present invention or by connecting an existing user data storage system to the present invention, or by first disclosing their existing accounts and feature preferences into the present invention or by connecting an existing user data storage system to the present invention and then engaging the use of the automatic enrollment system.

Processing then proceeds to Step P4-4 where the account server scans the universe of available account resources as provided by account issuers, incentive issuers, merchant issuers, and all such other entities that may proffer accounts with a feature set providing any user declared preference. It should be noted that the user may make demand of the present invention, by use of appropriate action and means, to initiate a scan for account discovery and further enrollment activities.

Next, processing proceeds to Step P4-5 whereby a scan has discovered an account proffering at least one of the user's declared feature preferences. A determination will be performed in Step P4-6 to ascertain that the user does not presently possess the discovered account. If the user presently possess the discovered account, then Step P4-7 will determine if the feature set of the account may be adjusted. If the feature set may be adjusted by upgrade or adjustment of a currently possessed user account by making application for adjustment through an enrollment application process, then processing proceeds to Step P4-9, otherwise processing would continue to Step P4-8 whereby information regarding the activities would be recorded and scanning for compatible accounts would resume at Step P44.

Thereafter, processing continues to Step P4-9 whereby the account server would establish communication linkages, both logical and physical, as required to access the discovered account issuer's enrollment application system. After establishing communication linkages, the account server identifies requested enrollment application data elements (e.g., user name, address) in Step P4-10 by the use of data tags (e.g., XML data programming language and data exchange standards).

Thereafter, processing continues at Step P4-11 whereby the account server reviews the data element compliance guidelines relating to the disclosure of user information (e.g., the disclosure of the user's name is to be provided, the disclosure of the user's date of birth is conditional, the disclosure of the user's gender is to be withheld) and provides appropriate data elements to the issuer's enrollment application system in an automated fashion. During the exchange of data requests and data disclosures, the issuer will review in Step P4-11 the condition of an enrollment application and ascertain the completeness of information according to their enrollment policies. If the account issuer determines that the user has data elements which may be conditionally provided to the account issuer, then the account issuer may attempt to persuade the account server to disclose the user's conditional data elements by adjusting the feature set of the discovered account in Step P4-13.

Processing then continues to Step P4-14 whereby the account issuer enrollment system will determine if sufficient user data has been provided in order to consider whether the enrollment application was sufficiently complete for further processing. Should it be determined that the user did not allow the disclosure of sufficient information to accommodate the issuer's guidelines, processing would continue to Step P4-15 whereby information regarding the activities would be recorded and scanning for compatible accounts would resume at Step P4-4.

Thereafter, Step P4-16 is engaged to perform a review of the enrollment application which may involve not only an account issuer evaluation, but also a review and analysis of the enrollment application by systems and resources the account issuer may employ in their review process. For example, if the discovered account was for a credit card being issued by Bank of America, it is possible that not only Bank of America would review the application but also Bank of America may have a credit rating bureau become involved in the review process.

After a review of the enrollment application, processing continues at Step P4-17 whereby a determination is made to either approve or reject the enrollment application. Should it be determined that the enrollment application has been rejected, processing would continue to Step P4-18 whereby information regarding the activities would be recorded and scanning for compatible accounts would resume at Step P44. If the enrollment application is approved, processing continues to Step P4-19 whereby the account issuer will create either a provisional account (e.g., a token account structure not activated for immediate use) or a fully constituted account (e.g., an account activated and ready for immediate use).

Processing then proceeds to Step P4-20 whereby the account issuer's enrollment system communicates the newly established account information to the account server where such information is stored and possibly forwarded to other user systems as expressed in Step P4-21.

Processing ends at Step P4-22.

It is contemplated that a portable computing device may be synchronised either automatically or on-demand by a user with an account server system, such synchronization not necessarily being performed during a transaction, by means of such related network systems in order to gain updated account owner and account information and thus possess the ability during a future enrollment opportunity to be able to perform the exchange of information by executing standalone processing of enrollment functions to automatically prepare an enrollment application for delivery to an account issuer.

While various embodiments of a preferred embodiment have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

Accordingly, having fully described the present invention by way of example with reference to the attached drawing figures, it will be readily appreciated that many changes and modifications may be made in the form and steps thereof and to the invention and to any of the exemplary embodiments shown and described herein without departing from the spirit or scope of the invention which is defined in the appended claims.

1: An automatic enrollment method for use in securing accounts, said method employing computer means having data storage means and network communications means and comprising the steps of:
(a) receiving authority to engage in automatic enrollment operations for an identified user having at least one declared account feature preference;
(b) conducting a continuous or intermittent scan of account resources upon notification of said authority to engage in automatic enrollment operations or by demand of said user to initiate a scan;
(c) dynamically matching said user's said at least one declared feature preference to the result of said scan; and,
(d) automatically effecting an enrollment application adapted to maximize the implementation of said user's said at least one declared feature preference.

2: The method of claim 1 comprising the further step of determining an account associated with at least one of said matched feature elements.

3: The method of claim 2 wherein a comparison is made to said user's existing accounts and a determination is made if the said determined account provides distinction sufficient to engage in an automatic enrollment application.

4: The method of claim 3 further comprising the steps of:
(a) identifying at least one issuer of said determined account; and,
(b) instantiating a data exchange for enrollment purposes with said at least one issuer of said determined account.

5: The method of claim 4 further comprising the step of automatically establishing such electronic and logical linkages as may be required to enable said user to engage in an automatic enrollment application.

6: The method of claim 4 further comprising the additional steps of automatically disclosing user information to accommodate the data requests of the at least one issuer of said determined account as regulated by said user's data disclosure compliance standards.

7: The method of claim 6 wherein said step of disclosing said user information is conditioned on an adjustment in said determined account features prior to the disclosure of said user information which is subject to conditional disclosure.

8: The method of claim 4 further comprising the steps of the at least one issuer of said determined account determining the completeness of enrollment data submitted.

9: The method of claim 4 further comprising the step of the at least one issuer determining the acceptance or rejection of the said enrollment data.

10: The method of claim 4 further comprising, upon acceptance of said enrollment data, the step of instantiating either a provisional account structure or a fully constituted account structure with the account features as established during the enrollment process.

11: The method of claim 4 further comprising the step of automatically securing and/or activating said determined account for said user.

12: The method of claim 4 further comprising the step of said at least one issuer disclosing the enrollment application decision and any related account information.

13: A system for creating and employing automatic enrollment solutions by dynamically selecting the means for processing an account application based on at least one user declared account feature preference, said system comprising:
(a) a processor;
(b) an input device connected to said processor;
(c) an output device connected to said processor;
(d) a clock device connected to said processor;
(e) a logic and control device connected to said processor;
(f) a memory connected to said processor storing instructions to control the operation of said processor;
(g) a communications device connected to said processor;
(h) a data storage device connected to said processor;
(i) the processor operative with the instructions in memory to:
i. record and/or connect data of users, feature elements, application solutions, and transactions;
ii. record and/or connect the user entry and ranking of at least one declared feature preference;
iii. receive requests to process enrollment applications;
iv. enable information to be available to users;
v. perform a continuous or intermittent scan of account resources upon system receipt of authority to process automatic enrollment operations concerning a user or by demand of a user to initiate a scan;
vi. conduct automatic evaluations of at least one available feature element based on a user's at least one declared feature preference and on a said scanning of account resources;
vii. disclose and adapt information to user requests;
viii. consummate enrollment applications; and,
ix. receive, record, evaluate, connect, and store user information and account activity.

14: A computer-readable storage medium encoded with computer-executable instructions to create and employ automatic enrollment solutions by dynamically selecting the means for processing an account application based on at least one user declared account feature preference, said computer-executable instructions, when executed by the computer, perform the steps of:
(a) recording and/or connecting data of users, feature elements, application solutions, and transactions;
(b) recording and/or connecting the user entry and ranking of at least one declared feature preference;
(c) receiving requests to process enrollment applications;
(d) enabling user access to information;
(e) processing an enrollment application including dynamically matching a user's at least one declared feature preference against a continuous or intermittent scan of account resources upon system receipt of authority to process automatic enrollment operations concerning said user or by demand of a user to initiate a scan;
(f) processing automatic evaluations of at least one available feature element based on a user's at least one declared feature preference and on a said scanning of account resources;
(g) disclosing and adapting information to users;
(h) consummating enrollment applications; and,
(i) receiving, recording, evaluating, connecting, and storing user information and account activity.
